(19) United States
(12) Patent Application Publication
(10) Pub. No.: US 2011/0102565 A1
(43) Pub. Date: May 5, 2011

(54) Spectral Imaging System

(76) Inventors: Xinghua Wang, Clifto Park, NY (US); Patrick Treado, Pittsburgh, PA (US); Charles W. Gardner, Gibsonia, PA (US); David Tuschell, Monroeville, PA (US); Jingyun Zhang, Upper Saint Clair, PA (US)

(21) Appl. No.: 12/441,420

(22) PCT Filed: Sep. 28, 2007
(86) PCT No.: PCT/US07/79880

§ 371 Date: Jul. 14, 2010

Related U.S. Application Data
(60) Provisional application No. 60/848,238, filed on Sep. 29, 2006.

(51) Int. Cl. H04N 7/18

(52) U.S. Cl. 348/61; 348/E07.085

(57) ABSTRACT

Macroscopic and microscopic samples are imaged through a spectral filter operable into the short wave infrared, e.g., to approximately 3200 nm. The sample is illuminated for reflective, transmissive, fluorescent and/or Raman imaging by a laser or metal-halide arc beam. The filter has tunable birefringent retarders distributed rotationally and stacked in stages leading up to a selection polarizer. Image forming optics and CCD cameras collect the luminance of each pixel in the spatially resolved image, at multiple wavelengths to which the filter is tuned successively. The filter stages have comb shaped transmission characteristics. Two filter stages with distinctly different characteristics can be cascaded, one or both being tunable. The combined transmission characteristic has narrow passbands where the bandpass peaks of the stages coincide and wide free spectral range where the peaks do not coincide. Embodiments are disclosed for forensic analysis, material composition and morphology, chemical compound identification and detection of biological species.

### CROSS REFERENCE TO RELATED APPLICATION

This application claims the priority of U.S. Provisional Patent Application Ser. No. 60/848,238, filed Sep. 29, 2006.

### BACKGROUND

1. Field

This disclosure relates to imaging systems with spectral filters for use, for example in aid of forensic analysis, to assist in determining the composition and/or morphology of chemical samples, and to identify biological threats. A spectral filter is provided with successive birefringent retarders and/or filter stages along a light propagation path including at least one selection polarizer. The retarders have thicknesses and relative rotational relationships that impart a predetermined change in polarization state to specific narrow wavelengths, so that those wavelengths are passed by the selection polarizer without substantial attenuation, whereas other wavelengths are rejected. A preferably-tunable multi-conjugate birefringent filter is disclosed, with plural retarders and plural stages, tunable into the short wavelength infrared (SWIR) region of the electromagnetic spectrum.

2. Relevant Art

A variety of chemical imaging systems are available from ChemImage Corporation of Pittsburgh, Pa., examples being the subjects of U.S. Pat. Nos. 6,917,423; 6,002,476; 6,717,668; 6,734,962; 6,765,668; 6,788,860; 6,950,184; 6,954,667; 6,965,793; 6,985,216; and 6,985,233, among others. Chemical imaging encompasses a range of possible systems and applications. A typical system contains provisions to illuminate or excite a sample, optics to collect and display an image of the sample, and in some cases instrumentation that is useful for spectroscopic analysis.

For spectroscopic analysis, a spectrometer may be used to determine the distribution of light energy over a wavelength range. Typically, a spectrometer spreads the light spectrum of an input beam over space with a refractor or over a repetitive time period by scanning. Sensors or graphic readouts collect measurements to show light energy as a function of wavelength. In analyzing a sample that has various features, such a process may require masking off of parts of the image, apart from a selected part, so as to obtain the spectrum of the selected part.

According to the present disclosure, reliance is placed on imaging spectroscopy. According to this technique, an image of the sample and its features is formed on a sensor array. Along the light path between the sample and the image plane, a spectral filter passes or blocks certain wavelengths such that features that provide contrast at certain colors or wavelength bands are emphasized.

A highly discriminating type of spectral filter, originally developed for astrophysical spectroscopy, can be used for chemical imaging. U.S. Pat. No. 6,992,809—Wang discloses a tunable multi-conjugate birefringent spectral filter. When propagating a light beam through birefringent retarder plates in a filter as disclosed in Wang '809, orthogonal vector components that are parallel to the ordinary and extraordinary axes of the birefringent retarder plates experience different refractive indices and propagate with different phase velocities. The ordinary and extraordinary components become displaced in phase. The phase displacement constitutes a change in polarization state.

As a nonlimiting example, assuming that a component of the input light beam at a given wavelength is plane polarized at 45° to the ordinary and extraordinary axes, and further assuming that the phase displacement at that wavelength amounts to π/2 radians, or an integer multiple thereof, then the emerging light beam will be plane polarized at an angle that is rotated by a corresponding multiple of 90° relative to the input polarization alignment. By introducing a selection polarizer aligned to this same angle, that component of the light beam passes with little loss of optical power. Components at other angles and at other wavelengths are attenuated by the polarizer.

The birefringence of the retarder, for example a quartz or calcite crystal, introduces a displacement in the propagating orthogonal components, and displacement occurs at all wavelengths. However, a given displacement of time or distance equals a relatively greater phase angle for a shorter wavelength, and a relatively smaller phase angle for a longer wavelength. Therefore, the change in polarization state that is introduced by the birefringent retarder varies with wavelength. The filter discriminates for specific wavelengths that align to the selection polarizer.

Actually, there is a series of wavelengths at which a given retardation produces the same phase angle displacement, because the displacement may extend over plural wavelength periods. The transfer function is a so-called comb filter of spaced pass bands, with a bandwidth typically measured as full width at half maximum or “FWHM,” separated by stop bands (spaces between bandpass peaks) of a width that defines a free spectral range or “FSR.”

If multiple retarders are placed sequentially in a stack along the light propagation path, it is possible to coordinate their thicknesses and their rotation angles so that the light emerging at the end of the stack has a given polarization state. For example, a phase displacement and resulting angular twist of 90° or 180° at the desired passband wavelength might be distributed over a set of sequential retarders. Using plural angularly displaced retarders improves the finesse of the filter. (The finesse is defined as the ration of FSR/FWHM.)

A number of filter types have been proposed wherein there is a given relationship of retarder thicknesses and angles. The Lyot configuration has retarders that are of different thicknesses, e.g., d-2d-d, and predetermined rotation angles. The Solc configuration has retarders of equal thickness that are either progressively rotated in a fan succession or are rocked back and forth relative to a reference angle. Different retarder materials have different birefringence values, and a retarder plate might be made in different thicknesses. These variations alter the comb filter transfer function by stretching or compressing the comb filter pattern along the wavelength axis.

A tunable retarder can be provided by optically aligning a fixed retarder and a liquid crystal. Varying the birefringence of the liquid crystal in that case, for example by applying an electric field, changes the birefringence of the combined fixed crystal and tunable liquid crystal. If the light signal propagates through plural retarder plates that have predetermined thicknesses and relative rotation angles, chosen to correspond to a particular passband wavelength, the spectral filter provides a high finesse filter with a very narrow bandpass. An even higher finesses can be obtained by use of plural serial filter stages as explained in U.S. Pat. No. 6,992,809, wherein overlapping passbands reinforce one another and non-overlapping passbands increase the FSR.

Existing tunable birefringent filter designs are not suited for use to filter for wavelengths in a Short Wavelength Infrared (SWIR) region, generally about 1800 nm to 3200 nm. It would be desirable to devise a tunable filter for this particular wavelength range, which would be useful in vibrational spectroscopy (e.g., Raman spectroscopy). However, if one attempts to configure known stacked-retarder tunable liquid crystal spectral filters to the SWIR region, there are problems. Among other things, C—H (carbon-hydrogen) bonds found in the materials and structures of various elements of the filter are believed to affect filter performance at least in the C—H stretch region of the SWIR area, where such bonds may produce absorption peaks.

Therefore, it would be desirable to devise a tunable filter that is optimized for the SWIR region, and in particular wherein performance in the C—H stretch region is not appreciably degraded by C—H bonds in the filter's structural elements.

### SUMMARY

It is an aspect of the disclosed developments to optimize a range of systems for imaging of chemical and biological substances and for assessing threats, by incorporating a multi-conjugate spectral filter arrangement as provided herein.

This and other aspects are met in systems for macroscopic and microscopic imaging of samples through a spectral filter operable into the short wave infrared, e.g., to approximately 3200 nm. A sample is illuminated for reflective, transmissive, fluorescent and/or Raman imaging by a laser or metal-halide arc beam directed to the front or rear. The spectral filter has preferably tunable birefringent retarders, distributed rotationally and stacked in stages leading up to a selection polarizer. Image forming optics and CCD cameras collect the luminance of each pixel in the spatially resolved image, at each of multiple wavelengths to which the filter is tuned successively. The filter stages have comb shaped transmission characteristics. Two filter stages with distinctly different characteristics can be cascaded, one or both being tunable. The combined transmission characteristic has narrow passbands where the bandpass peaks of the stages coincide and wide free spectral range where the peaks do not coincide. Embodiments are disclosed for forensic analysis, material composition and morphology, chemical compound identification and detection of biological species.

### BRIEF DESCRIPTION

There are shown in the drawings certain embodiments presented as examples, it being understood that the present developments are not limited to the structures and instrumentalities presented as examples, and are capable of embodiment in other ways consistent with the appended claims. In the drawings,

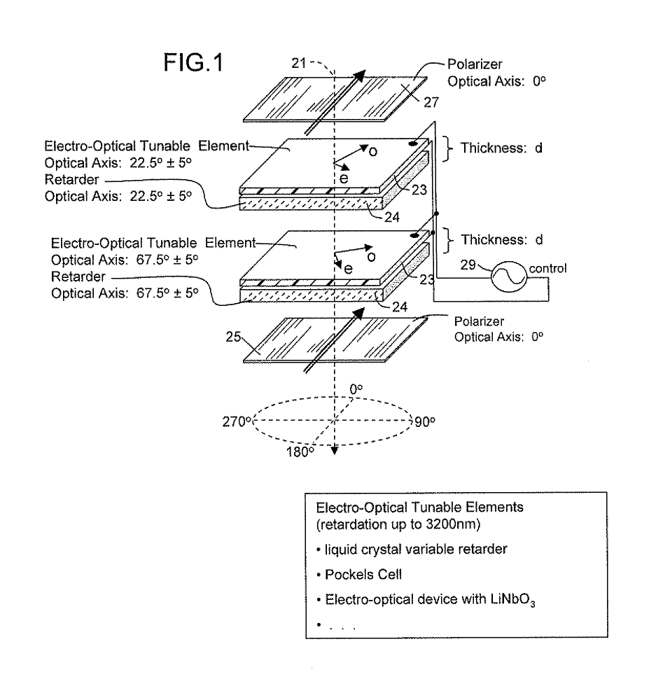

FIG. 1 is an exploded perspective illustration showing a two-retarder tunable multi-conjugate filter for use in the short wavelength infrared spectral filter imaging system of this disclosure.

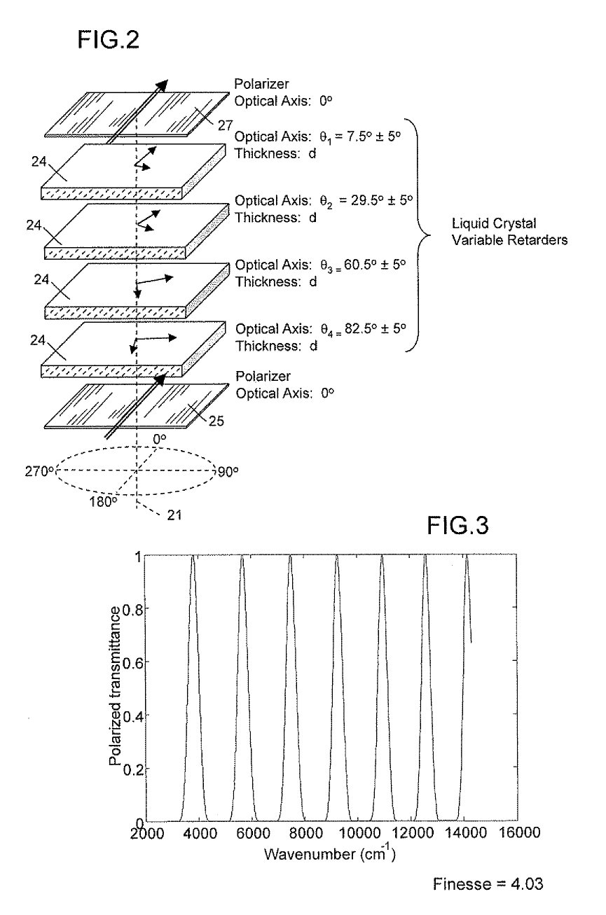

FIG. 2 is an exploded perspective view of a four retarder multi-conjugate filter, in this example using fixed retarders.

FIG. 3 is a plot of polarized transmittance versus wave number demonstrating the transfer function of the filter of FIG. 2.

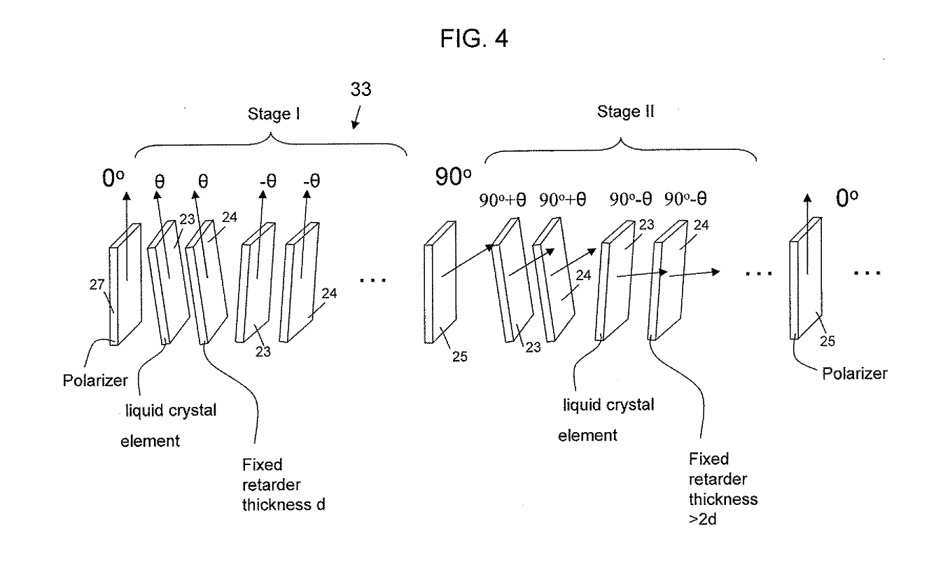

FIG. 4 is an exploded view of a multi-conjugate filter comprising a plurality of serial stages, each stage comprising plural rotationally arranged tunable elements, each tunable element comprising an aligned electrically tunable liquid crystal and fixed retarder.

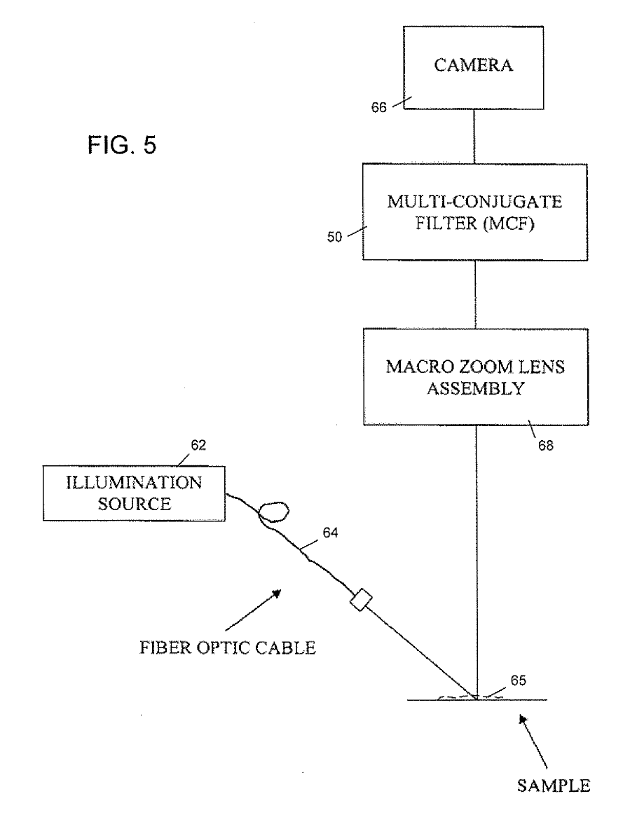

FIG. 5 is a schematic illustration of an illumination and imaging system employing the multi-conjugate filter as described, including provisions for coupling of at least one type of illumination source and an optical lens assembly for presenting and recording images through the filter.

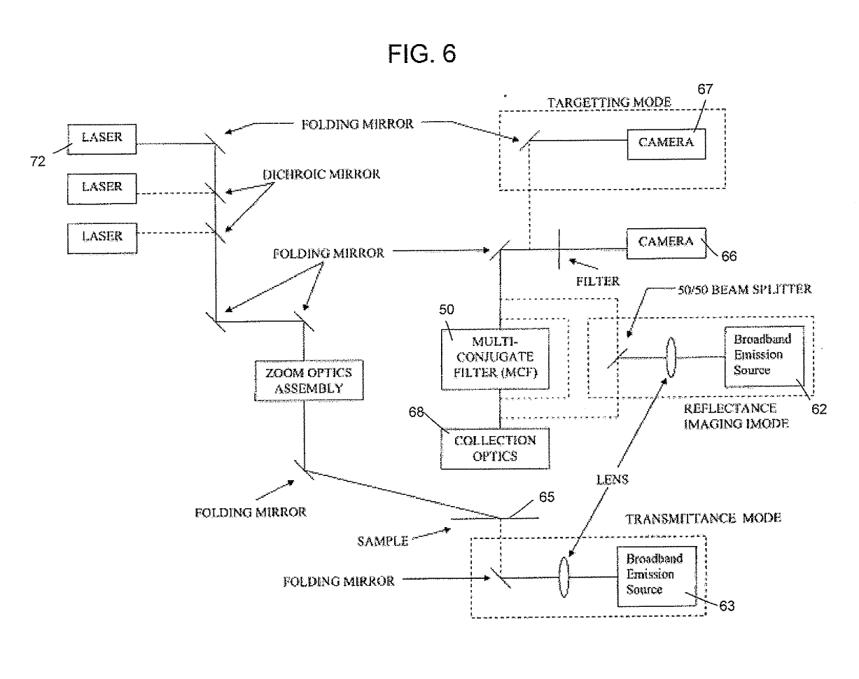

FIG. 6 is a block diagram showing an imaging system with multiple alternative illumination and image collection modes, employing the multi-conjugate filter as described.

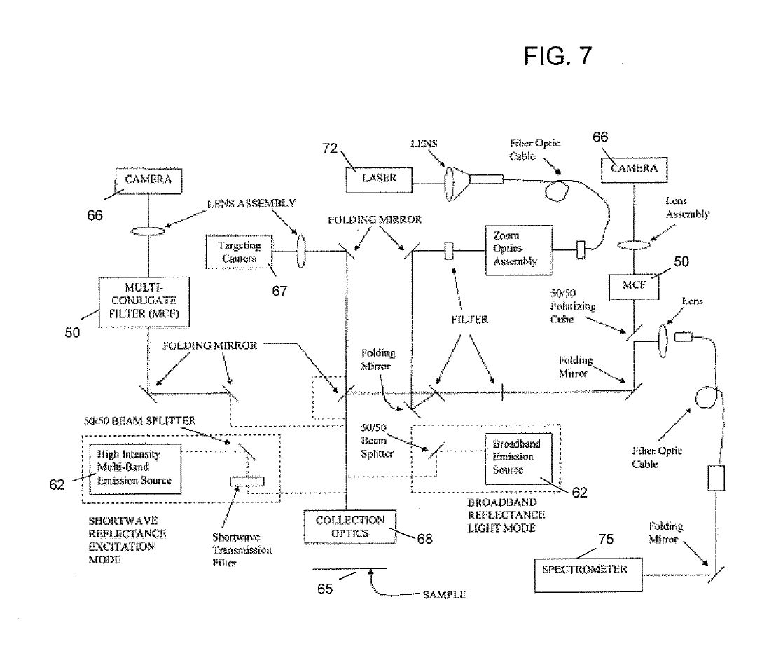

FIG. 7 is a block diagram showing an alternative imaging system comprising multiple filters and cameras together provisions for sample excitation and spectroscopy.

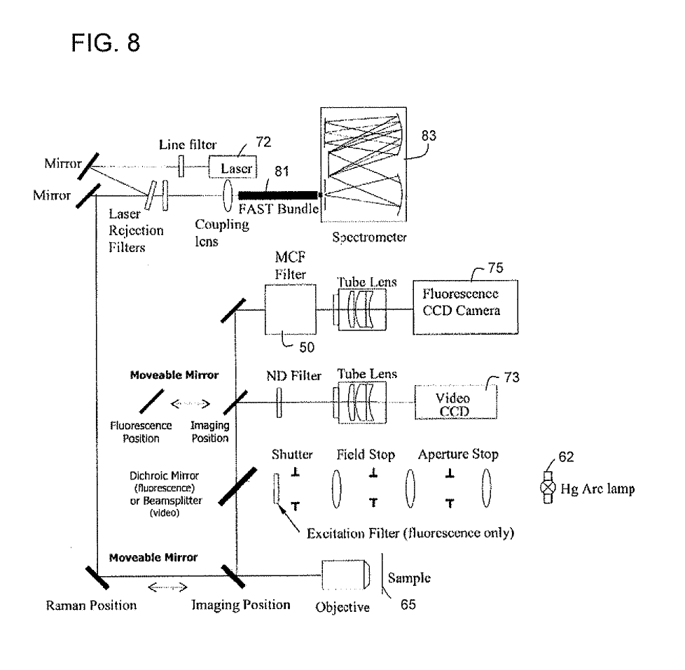

FIG. 8 is a block diagram showing optical and illumination provisions of another embodiment adapted for Raman imaging.

### DETAILED DESCRIPTION

According to the present disclosure chemical and biological imaging systems, including apparatus for assessing threats by detection of certain chemical or biological species, are provided with a high performance spectral imaging system, operably into wavelengths in the short infrared range, particularly up to 3200 nm. FIGS. 1-4 detail certain multi-conjugate spectral filter structures. FIGS. 5-8 depict imaging systems for particular applications, incorporating multi-conjugate filters as described.

FIG. 1 illustrates an embodiment a bandpass multi-conjugate filter (MCF) for the SWIR wavelength range (at least up to 3200 nm). This two-element filter stage employs, along a light propagation path 21, two tunable optical retarders 23 (e.g., liquid crystals) aligned to and paired with two fixed retarders 24 that have equal thicknesses “d” but different optical axes of orientation, shown by the perpendicular arrows labeled “o” and “e” as the ordinary and extraordinary axes. The filter also comprises at least one selection polarizer 25 on the output side, and for purposes of this description is shown with an optional reference polarizer 27 on the input side.

Assuming that the input reference polarizer 27 defines an optical axis at zero degrees, plane polarized light passing through polarizer 27 is incident on the initial retarder at an angle to the optical reference axis of the retarder, for example the ordinary axis. Inasmuch as the successive retarders are relatively rotated, a first vector component of the light passing the polarizer is parallel to the ordinary axis of the retarder and a second vector component is parallel to the extraordinary axis. The relative proportions of the light energy coupled to the respective ordinary and extraordinary axes is a function of the sine and cosine of the angle between the input polarizer and the first retarder.

The first retarder preferably is electrically tunable or switchable by a control 29, so as to apply a differential phase delay along the ordinary and extraordinary axes due to birefringence. The plane polarized light passing the input polarizer 27 is divided into phase differentiated components. It can be assumed that the input light is broadband (although the filter will operate on any wavelengths that are present).

The phase differentiated components that propagate through the first retarder then encounter the second retarder, which is rotated relative to the first retarder and relative to the plane polarized output of the input reference polarizer 27. By virtue of the rotation, each of the two phase differentiated components from the first retarder is aligned at an angle relative to the optical reference axis of the second retarder. A first vector component of each of the phase differentiated components from the first retarder is subjected to a differential phase delay by the second retarder. Therefore, light emerging from the second retarder comprises four phase differentiated components.

The relative rotations of the retarders are arranged to spread the power of the phase differentiated light signals between the sine and cosine components at each retarder. In FIG. 1, two retarders are provided, producing four phase differentiated components that are incident on the output polarizer 25 (also known as a selection polarizer).

By providing additional relatively rotated retarders, more phase differentiated components are obtained. In FIG. 2, there are four retarders 24, which result in 16 phase differentiated components at the selection polarizer. In the embodiment of FIG. 2, the retarders are not shown as being tunable. However it is possible as in FIG. 1 to provide for each fixed retarder 24 an electro-optical tunable or switchable element, for example of the categories shown in the table in FIG. 1.

The various phase differentiated components incident on the selection polarizer 25 add and interfere at the selection polarizer to produce peaks and nulls. Furthermore, the differential retardation of orthogonal components of the light at each retarder 24 alters the polarization state of the light due to differential phase retardation. Polarization state is a matter of the phase and amplitude relationships of orthogonal electromagnetic vector components. For plane polarized light, the orthogonal components are equal in amplitude and either are in phase or are 180° out of phase.

Referring to FIGS. 1 and 2, for a set of periodically related specific wavelengths, the differential phase retardation of plane polarized light incident on the input reference polarizer 27, from propagating through the serially placed retarders 24 (or 23 and 24 in FIG. 1) is precisely the retardation necessary to align the polarization state of those wavelengths to the selection polarizer 25. These wavelengths pass through the selection polarizer 25 with little attenuation, while other wavelengths are strongly attenuated.

In the filter stage of FIG. 1, the tunable retarders 23 are shown placed above the fixed retarders 24 with which the tunable retarders are rotationally aligned in conjugated pairs. Multiple conjugates pairs (23, 24) are shown sandwiched between the two polarizers 27, 25. It is possible to vary the specific structure of the retarders and to use different arrangements of retarder thicknesses and/or relative birefringence values, provided that the result is that a selected wavelength emerges in a polarization state aligned to the selection polarizer 25.

In one embodiment, the electro-optical tunable or switchable elements 23 comprise controllable birefringence elements for each retarder in the stack of retarders. The retarders can each comprise an electro-optical tunable element 23 such as a liquid crystal, that is optically aligned with a fixed retarder 24 such as a calcite or quartz crystal, such that the retardances of the two elements add together. In that case, varying the control applied to the tunable element 23 is functionally similar to changing the thickness of a single element retarder 24. The birefringence of the controllable birefringence retarder elements 23 are varied in a coordinated manner to change the transfer characteristic of the filter, i.e., to change the wavelength that is passed at the selection polarizer 25.

In the arrangement shown in FIG. 1, fixed retarders 24 and electrically controllable retarder elements 23 are aligned in the directions shown by the arrows, and are affixed to one another such that each conjugated pair contributes phase retardation as a single variable retarder. According to one embodiment the dimensions and the range of control provide a phase shift (relative retardation of orthogonal components) sufficient for selection of a pass bandwidth up to 3200 nm, in the short wave infrared.

In one embodiment, the electro-optical elements 23 comprise liquid crystals that are variable in birefringence with variation in the control voltage applied by control 29. The liquid crystals can be coupled to fixed retarders of equal thickness, and tuned in unison. The spectral filter has a comb filter transmission characteristic (a characteristic of spaced narrow bandpass peaks between free spectral bandpass nulls), as shown in FIG. 3. Increasing and decreasing the birefringence by tuning the liquid crystals tend to stretch and contract the transmission characteristic along the wavelength scale.

Instead of or in addition to employing electric-field variably tunable liquid crystal elements, the retarders in FIG. 1 can comprise other variable retarders. As shown in the table in FIG. 1, examples include Pockels cells and other electro-optical devices, for example comprising Lithium Niobate (LiNb0₃).

FIG. 2 illustrates an exemplary four-element multi-conjugate spectral filter that has only fixed retarders 24 (i.e., without tunable birefringent elements associated with the fixed retarders). Each fixed retarder 24 in the stage of retarders between polarizers 27, 25 in FIG. 2 is shown to be of equal thickness “d.” Each retarder has a different optical axis. In one embodiment, the thickness of each such fixed retarder may be substantially 50 microns.

In FIG. 3, a plot of a transmission characteristics (transmittance as a function of wave number) shows the spectral performance data for the filter stage shown in FIG. 2. In this case, the optical axes of the retarders are spread symmetrically over a set of advancing angles from the reference polarizer 27 to the first retarder, between the retarders and up to the selection polarizer 25, namely from 0° (polarizer 27) to 7.5°−29.5°−60.5°−82.5° and 90° (polarizer 25).

The sharp bandpass peaks with clear separation between peaks (high FSR or Full Spectral Range) and low FWHM (Full Width at Half Maximum) and high suppression outside of bandpass range are visible in the transmission plot of FIG. 3. The finesse value for the filter and transmission characteristic as shown, defined as the ratio of FSR to FWHM, is approximately 4.03.

In the embodiment of FIG. 1, using a smaller number of retarders 23/24, the angular advance is similarly symmetrical at 0°−22.5°−67.5°−90°. It will be appreciated that a greater number of retarders can be similarly arranged than shown in either FIG. 1 or FIG. 2. In general, adding to the number of retarder stages improves the discrimination of the filter by narrowing the pass bandwidth at FWHM.

It is generally the case that varying the birefringence or retarder thickness in a spectral filter as shown has the effect of stretching or compressing the transmission characteristic along the scale of bandwidth. By providing a plurality of stages disposed serially along a light propagation path with substantially different birefringences or thicknesses (comparing one stage against another), it is possible to provide stages that have substantially different transmission characteristics. For plural serially arranged stages, as shown in FIG. 4, and due to the capability of tuning, one or more bandpass peaks in the transmission characteristic of one stage may wholly or partly correspond to one or more bandpass peaks in the transmission characteristic of another stage. Other peaks for one stage may correspond to a free spectral range zone in the transmission characteristic of the other stage (i.e., to a stop band).

The transmission characteristics of the serially disposed stages multiply and reinforce one another where bandpass peaks align, and disable any bandpass peak that is aligned to a stop band of another stage. More particularly, when certain bandpass peaks in serial stages are caused (e.g., by tuning) to wholly or partly align, the transmission characteristic of the multi-stage filter comprising the serial stages is characterized by a narrower bandpass peak and a greater rejection ratio than the characteristic of either stage alone at the corresponding wavelength. Where a peak in the transmission characteristic of one stage aligns with a null in the other stage, the null governs. Thus, where the bandpass peaks of the stages are misaligned, the result is a larger free spectral range between the next nearest bandpass peaks at larger or smaller wavelengths. The transmission characteristic of the multi-stage filter has a free spectral range (band-stop space between bandpass peaks) that is greater than that of either stage alone. Whereas reinforcement of the serial stages in this way results in a narrower bandwidth and a greater free spectral range, the finesse value for the filter is improved as compared to the finesse of either stage. The finesse values of the stages are multiplied.

In order to exploit this aspect, it is advantageous that at least one of the serially disposed stages and optionally two or more of the stages, or all of the stages, are made tunable. As discussed, tuning a stage allows the comb-shaped bandpass characteristic to be stretched or compressed on the wavelength axis. By tuning one of the stages, the transmission characteristic is adjusted to bring a bandpass peak from the tunable stage(s) into alignment with the bandpass peak of the other stages, which in one embodiment can be fixed (not tunable).

FIG. 4 depicts two stages of an exemplary multi-conjugate filter according to an embodiment wherein each of plural serially disposed stages is tunable (two stages being shown). The stages are tunable because each pair of cooperating filter elements comprises a fixed retarder 24 and a tunable retarder 23, aligned optically with one another such that their thickness and birefringence are added. The fixed and tunable element have distinct birefringence values. However the tunable elements within each stage are tuned in coordination with one another (e.g., in unison). The tunable elements in the successive stages are tuned to different values. The filter stages are serially arranged but separated by respective selection polarizers 25 as shown in FIG. 4, such that the selection polarizer of a first stage constitutes the reference or input polarizer for the next stage, along the direction of light propagation.

As shown in FIG. 4, each fixed retarder 24 has a corresponding, adjoined controllable birefringence element 23, for example a liquid crystal. Although the retardations may be the same (and controllable in unison) within a given stage, by providing a substantial difference in the element thickness and/or birefringence from one stage to another (by using different thicknesses or by controlling to different birefringences), the characteristics of the stages are made distinctly different. One stage thus has a substantially narrower bandpass at FWHM but has only a small free spectral range. The other stage has a large free spectral range but a bandpass at FWHM that is perhaps relatively wide and/or not as highly discriminating. Provided that one or more of the stages is tunable to cause the bandpass peaks to overlap, the serially coupled stages have the narrower FWHM of one stage and the wider FSR of the other stage. The embodiment in FIG. 4 thus can provide high finesse, narrow bandwidth, and good ratio between transmission and rejection light energy levels.

In alternative embodiments, some retarder stages may include only tunable birefringences, or only fixed birefringences. Plural tunable or fixed birefringence elements can be affixed to one another to increase the thickness or to allow a larger range of control. Such filter configurations may provide distinctly different FSR-FWHM attributes from one stage to another. However tuning to overlap a bandpass peak enables the multi-conjugate filter comprising plural stages to be tuned to exploit the best attributes of each stage.

Where there is a substantial difference in birefringence or retarder thickness, such as the thickness “d” in one stage and “2d” in another stage as shown in FIG. 4, tuning the transmission characteristic with the wider bandpass peaks effectively enables selection of a narrow bandpass peak in the characteristics of the other stage(s) peaks. At the same time, nulling adjacent narrow peaks and thus improving free spectral range and filter finesse.

Additional details, information and examples of multi-conjugate filter configurations may be obtained from U.S. Pat. No. 6,992,809; pending application Ser. No. 11/112,654 (pending as a continuation in part of '809 patent); and US application publication 2007/0139772, corresponding to Provisional Application 60/752,503. The disclosures of all of these documents are incorporated herein by reference in their entireties.

FIG. 5 illustrates a block diagram of an exemplary macroscopic chemical imaging system equipped with a multi-conjugate filter 50 (“MCF”), namely a birefringent filter containing relatively rotated retarders, preferably with one or more stages wherein the retarders are tunable, and a selection polarizer. The imaging system of FIG. 5 can be embodied by applying the multi-conjugate spectral filter as described herein and shown, for example in FIG. 1 or 4. This embodiment is based on modification of the Condor™ spectral imaging system marketed by ChemImage Corporation of Pittsburgh, Pa.

According to this embodiment, an illumination source 62 such as a metal halide arc lamp is coupled, for example by a fiber optic cable 64, to illuminate a forensic sample or the like 65 in a reflected or fluorescent light wide field imaging process. Each pixel or point in the sample image may be displayed and presents a luminance that is digitized and recorded simultaneously for the pixels using a digital camera 66 arranged to view the sample through a macro zoom lens assembly 68. The apparatus can be operated while stepping the MCF spectral filter 50 successively through a series of wavelengths. In this way the apparatus can collect high resolution spectrally distinct and spatially resolved images. Depending on the number of spectral wavelengths recorded, this technique can record a great deal of information in that each pixel in each image represents a spectral sample at the pixel position in the image.

The multi-conjugate filter 50, embodied for example as shown in FIG. 1 or 4, preferably is used to provide desired wavelength tuning while recording spectrally distinct spatially resolved images of the sample, for example using the macro zoom lens assembly 68 to control magnification. The filter 50 can be tuned to select for responses in general wavelength bands, e.g., by tunably selecting exemplary nominal red, blue and green wavelengths. The filter 50 can be tuned to particular wavelengths or sets of wavelengths that are known to characterize a particular material or composition of interest. Alternatively, the filter can be tuned to select for responses at incremental steps through a range of wavelengths (e.g., regularly spaced or irregularly spaced to place extra spectral resolution in wavelength bands of particular interest). In this manner, the apparatus obtains and records, and concurrently can display, a spectral response of a sample for general comparison with other samples or references. By sampling over a wide range of wavelengths up to the short wavelength infrared, a spectral response that may identify or distinguish a sample can be obtained in a way that is highly discriminating, repeatable, and for which results are available quickly and conveniently.

Application of the multi-conjugate filter 50 to a wide field chemical imaging apparatus is particular apt in the study of forensic samples because detailed spectrally distinct images can reveal information that cannot be obtained using conventional techniques. The reflected or fluorescent light from each point in the sample image is measured at a tunably selected wavelength. At different wavelengths features in a sample image often are characterized by more or less contrast, enabling visualization of detail by selecting spectra wherein a feature of interest is clearly seen. By collecting a set of spectrally distinct spatially resolved images, it is possible to identify and overcome background interference and contrast challenges.

Among other applications, the wide field imaging apparatus with multi-conjugate spectral filter 50 is useful in forensic investigations. These include, for example, determination of gunshot residue, revealing and enabling forensic analysis of fingerprints on complex backgrounds, identification of inks and stock as well as distinctions among inks and stock on questioned documents, characterization of adhesives, viewing of normally indistinct features such as bands on TLC plates, and characterization of stains.

In one embodiment, a choice for illumination sources 62 is provided, including for example a metal halide 400 W arc lamp. The system can selective image in a desired spectral range. Software is provided for control of system subassemblies, e.g., for stepping through a range of wavelengths or by selective imaging at key wavelengths or wavelength bands and for acquiring spectrally-distinct spatially-resolved images that are subjected to analysis. The images are readily displayed to enable visualization of detail, and the image data is subject to data processing steps, including but not limited to generation of standard format image files.

Camera 66 preferably has a dense two dimensional array of charge coupled elements, or can have a linear array across which the image is scanned and sampled in time divisions. In any event, a large number of pixel points can be recorded, and where desired each pixel point is spectrally sampled for luminosity at particular wavelengths or bands. The apparatus can collect hundreds of thousands of measurements of exact colorimetric (reflective) and/or fluorescence (emissive) light information in image formats. Additional information is available regarding uses and benefits of the ChemImage Condor™ system may be obtained at http://www.chemimage.com.

FIG. 6 depicts a block diagram of an exemplary chemical imaging system equipped with a multi-conjugate filter 50 according to the teachings of the present disclosure. As a chemical imaging system, the apparatus also has potential application to certain forensic investigations, but can be adapted for a number of other uses as well. The chemical imaging system of FIG. 6 can be based on the CI WHIP™ system marketed by ChemImage Corporation of Pittsburgh, Pa., as suitably modified to include a multi-conjugate spectral filter 50 such as that shown in FIG. 1 or 4.

The system in FIG. 6 may be configured to accommodate three different types of lasers 72 for desired illumination, and can selectively employ broadband light sources 62, 63 for reflective or transmissive illumination, respectively. In the block diagram illustrations, including FIGS. 6-8, dashed lines represent alternative signal paths and selectively deployed subassemblies. The system is versatile and may be configured or selectively deployed to perform Raman chemical imaging, bright field transmission/reflection imaging, visible absorption imaging, laser-induced luminescence chemical imaging, and cross-polarized transmission imaging.

In this embodiment, the multi-conjugate filter 50 is associated with the image collection optics 68 directed toward the sample. Suitable zoom optics can be associated with illumination by the laser(s) 72, as are dichroic mirrors that act as polarizers. The alternative illumination sources that are selected by introducing movable mirrors to fold the associated optical path, can comprise a selected one or a selected combination of a plurality of lasers 72, a broadband illumination source 62 for reflective imaging and an broadband illumination source 63 for transmittance image (i.e., with the sample 65 illuminated from behind). In addition to a camera 66 for high resolution and spectral data collection, a targeting mode lower resolution camera 67 can be deployed, optionally bypassing the spectral filter 50. Appropriate zoom, image collection, illumination collimation and other optics are provided, as well as various mirrors for deploying or decoupling the functional elements.

In the embodiment of FIG. 6, a multi-conjugate filter 50 (“MCF”) such as that shown in FIG. 1 or FIG. 4, may be incorporated to accomplish desired tuning for selecting an imaging wavelength or for collecting a spectrum of wavelengths that is spatially resolved by pixel position. The particular manner of operation of the MCF can depend on the imaging mode being used. This system provides the same field of view for all imaging modes as can be seen from the system block diagram in FIG. 6, although illumination, spectral filtering and camera options can be employed as needed in different modes. Additional information about the CI WHIP™ system may be obtained from http://www.chemimage.com.

Throughout the drawings, the same reference numbers are used where possible to identify functionally corresponding elements in the respective embodiments. It should be understood, however, that the particular specifications and model types for these elements need not be the same in each case.

FIG. 7 is a block diagram showing an exemplary molecular chemical imaging system equipped with two MCFs 50 according to the teachings of the present disclosure. In one embodiment, the system of FIG. 7 can be the Falcon II™ system marketed by ChemImage Corporation of Pittsburgh, Pa., modified to include the two multi-conjugate filters according to the teachings of the present disclosure, nonlimiting examples being shown in FIGS. 1 and 4.

The system in FIG. 7 is configured to produce two-dimensional and three-dimensions (2D and 3D) molecular images using Raman spectroscopy. Real-time Raman spectroscopy and Raman chemical imaging can also be carried out using the system of FIG. 7. Broadband and shortwave reflectance imaging modes are also provided in the configuration of FIG. 7. As in the previous embodiment, selectively deployed elements and signal paths are represented by dashed lines.

Wavelength tuning for these imaging applications can be accomplished using a bandpass multi-conjugate filter 50 according to the teachings of the present disclosure (e.g., as shown in FIG. 1 or 4). The system in FIG. 7 employs two separate paths containing a camera 66 and multi-conjugate filter 50 as shown. The MCF 50 and camera 66 shown on the left-hand side of FIG. 7 may be employed for fluorescence and NIR (near infra-red) chemical imaging, whereas the MCF 50 and camera 66 on the right-hand side may be used for Raman chemical imaging. These signal paths are selected by operation of appropriate image path folding mirrors. In addition to alternative illumination sources 62, one having an associated shortwave transmission filter, this system also employs a non-imaging type spectrometer 75. Various filters and path folding mirrors to couple and decouple operable elements to be deployed.

The FALCON II™ Molecular Chemical imaging System combines the benefits of wide field Chemical Imaging with dispersive Raman spectroscopy. This combination of is configured support powerful analytical techniques, and to deploy multiple hardware options. As in previous embodiments, operational control software, analysis and user interface option s are provided.

Chemical imaging according to the embodiment of FIG. 7 combines digital imaging and Raman spectroscopy to obtain molecular images. Such images are used to reveal material morphology, composition, structure and concentration. This system includes powerful illumination and spectroscopic capabilities while in some respects emulating a microscope, so as to permit the user's natural visual senses and perception to make complex analysis intuitive and straightforward. This system can produce two-dimensional and three-dimensional molecular images with speed and quality.

According to the embodiment shown in FIG. 7, the system is capable of real-time simultaneous imaging and non-imaging spectroscopy. The user is able to identify critical regions of the image and couple the associated image area for spatially distinct but non-imaged spectroscopic analysis. Additionally, by employing the multi-conjugate filter as described herein, a set of spatially resolved spectrally distinct images of the sample are collected and can be viewed or analyzed through automated image processing techniques for high throughput hyper-spectral screening of materials.

Among other capabilities, the FALCON II™ performs dispersive Raman spectroscopy at high spectral resolution for microscopy applications. Little or no sample preparation normally is required. Raman spectroscopy and Raman Chemical Imaging are compatible with aqueous systems. Non-destructive sample characterization can be performed through glass containers, thin plastic bags or blister packs. The FALCON II™ dispersive spectrometer incorporates a performance-optimized spectrometric CCD and ultra-low-noise electronics. Software control of the CCD and spectrometer creates a practical detection system to produce high quality Raman spectra.

The standard dispersive Raman spectrometer provides resolution to 2 cm⁻¹. The liquid crystal tuned MCF imaging spectrometer can resolve a spectral bandpass of about 9 cm⁻¹ and is controllable as described about to tune at fine wavelength increments. Spectral resolving power of less than 0.1 cm⁻¹ has been consistently achieved. Additional detail about the Falcon-II™ system may be obtained from http://www.chemimage.com.

A further advantageous embodiment, shown in FIG. 8, comprises a chemical/bio-threat detection system equipped with an MCF filter 50 according to the present disclosure. In one embodiment, the system in FIG. 8 is substantially an Eagle™ system as marketed by ChemImage Corporation of Pittsburgh, Pa., suitably modified to include MCF 50 according to the teachings of the present disclosure. The system in FIG. 8 is advantageously configured as a transportable system for detection of hazardous materials in the field. The system may include the necessary hardware for microscopic examination, Raman spectroscopy and fluorescence spectroscopy for rapid identification of chemical and bio threats.

The spectral imaging system as embodied in FIG. 8, enables initial use of fluorescence chemical imaging, especially to determine the presence and location of any particle(s) of bio-threat agents or suspects. Once located, the system may use Raman spectroscopy to identify the agent. Identification and classification are performed using the control and analysis software and built-in spectral reference library, containing identification criteria for a library of potential bio threats. The power of Raman spectroscopy enables the system in FIG. 8 to identify both chemical and biological threats, simultaneously using the same sample.

In FIG. 8, two charge coupled device (“CCD”) cameras 73, 75 are provided, at least one of which (73) is configured to record a moving image (i.e., video) of the sample. A movable mirror associated with the video CCD camera is arranged to intercept the light path for directing the light through a neutral density (“ND”) filter. The light input to the fluorescence filter is attenuated except at a spectral passband, namely by the multi-conjugate spectral filter described above. In this manner the fluorescence CCD camera can be sensitive to relatively low energy fluorescent light emission.

As in previous embodiments, laser and broadband illumination sources 72, 62 are made available, as well as two cameras 73, 75 and an additional spectrometer 83 besides the spatially resolved spectrally tuned imaging spectrometer embodied in the MCF 50 and camera 75 as described in the present disclosure. In different operational modes, the respective light sources and light destinations are coupled into respective light propagation paths using movable mirrors and associated lenses.

In FIG. 8, a Fiber Array Spectral Translator (“FAST”) fiber bundle 81 may be used to obtain Raman spectra from multiple sample points simultaneously. The fluorescence imaging may be used for targeting applications (with UV excitation and visible emissions), and the point-source Raman spectroscopy may be used for identification (with 532 nm laser excitation). The sample may be in the form of powder or liquid. Additional general information about the Eagle™ system may be obtained from http://www.chemimage.com.

The foregoing discussion of embodiments and alternatives provide a range of examples and aspects that characterize the subject matter of this disclosure. However, reference should be made to the appended claims to determine the scope of the invention in which exclusive rights are claimed.

What is claimed is:

1. A macroscopic chemical imaging system, comprising:
an area provided for presentation of a sample to be imaged;
wherein the area is subjected to illumination from an illumination source;
a macro lens assembly providing an optical path from the sample to an image collection camera; and,
a spectral filter disposed along the optical path from the sample to the image collection camera, the spectral filter having a filter transmission characteristic that passes at least one wavelength passband and blocks at least one wavelength stop band;
wherein the spectral filter comprises a filter stage having a plurality of birefringent retarder elements disposed at different rotational orientations relative to an input polarization orientation, along a light propagation path leading up to at least one selection polarizer, wherein the retarder elements are arranged to impart a differential phase delay to at least one component of the wavelength passband, such that a polarization alignment of said at least one component is aligned to the selection polarizer.

2. The macroscopic chemical imaging system of claim 1, wherein the spectral filter comprises at least one said filter stage that is a tunable stage wherein the filter transmission stage has a comb filter characteristic, and further comprising a control operable to controllably adjust the retarder elements of said tunable stage to alter the comb filter characteristic for selection of the wavelength passband that is aligned to the selection polarizer.

3. The macroscopic chemical imaging system of claim 2, wherein the spectral filter comprises a multi-conjugate filter with at least two said filter stages, disposed serially along the light propagation path, wherein the two filter stages have different comb filter characteristics over an operational tuning range, said tunable stage being adjustable such that the comb filter characteristic of the tunable stage has at least one bandpass peak that overlaps a bandpass peak of an other of said at least two filter stages.

4. The macroscopic chemical imaging system of claim 3, wherein the retarder elements of the tunable stage each comprises a fixed retarder and an electro-optical tunable element, a combination of the fixed retarder and the electro-optical tunable element of each of said retarder elements having a rotational orientation and a birefringence that is related to a rotational alignment and birefringence of each other of the retarder elements in the tunable stage so as to cause the bandpass peak to interfere strongly at a polarization orientation aligned to the selection polarizer, and wherein at least one of the birefringence of the retarder elements in the tunable stage and a thickness of the retarder elements in the tunable stage imparting a distinctly different phase delay from a phase delay imparted by the other of the at least two filter stages.

5. A chemical imaging system, comprising:
an area provided for presentation of a sample to be imaged;
wherein the area is selectively subjected to illumination from a source and along an illumination direction comprising a broadband illumination source, at least one laser illumination source, a front reflective illumination source and a rear transmissive illumination source;
image collection optics comprising at least one lens defining an optical path from the sample to an image collection camera; and,
a spectral filter at least selectively disposed along the optical path from the sample to the image collection camera, the spectral filter having a filter transmission characteristic that passes at least one wavelength passband and blocks at least one wavelength stop band;
wherein the spectral filter comprises a filter stage having a plurality of birefringent retarder elements disposed at different rotational orientations relative to an input polarization orientation, along a light propagation path leading up to at least one selection polarizer, wherein the retarder elements are arranged to impart a differential phase delay to at least one component of the wavelength passband, such that a polarization alignment of said at least one component is aligned to the selection polarizer.

6. The chemical imaging system of claim 5, wherein the spectral filter comprises at least one said filter stage that is a tunable stage wherein the filter transmission stage has a comb filter characteristic, and further comprising a control operable to controllably adjust the retarder elements of said tunable stage to alter the comb filter characteristic for selection of the wavelength passband that is aligned to the selection polarizer.

7. The chemical imaging system of claim 6, wherein the spectral filter comprises a multi-conjugate filter with at least two said filter stages, disposed serially along the light propagation path, wherein the two filter stages have different comb filter characteristics over an operational tuning range, said tunable stage being adjustable such that the comb filter characteristic of the tunable stage has at least one bandpass peak that overlaps a bandpass peak of an other of said at least two filter stages.

8. The chemical imaging system of claim 7, wherein the retarder elements of the tunable stage each comprises a fixed retarder and an electro-optical tunable element, a combination of the fixed retarder and the electro-optical tunable element of each of said retarder elements having a rotational orientation and a birefringence that is related to a rotational alignment and birefringence of each other of the retarder elements in the tunable stage so as to cause the bandpass peak to interfere strongly at a polarization orientation aligned to the selection polarizer, and wherein at least one of the birefringence of the retarder elements in the tunable stage and a thickness of the retarder elements in the tunable stage imparting a distinctly different phase delay from a phase delay imparted by the other of the at least two filter stages.

9. The chemical imaging system of claim 5, further comprising at least one selectively movable light path folding mirror associated with at least one of an illumination path and an image collection path, wherein the mirror is deployable for at least one of:
selectively coupling one of a plurality of lasers into an illumination path to the sample as said front reflective illumination source,
selectively coupling a first broadband emission source on a light path toward the sample as said front reflective illumination source,
selectively coupling second broadband emission source on a light path toward the sample as said front reflective illumination source,
selectively coupling at least one of an image collection camera and a targeting camera along the image collection path, and
selectively removing the spectral filter from the image collection path during coupling of the targeting camera along the image collection path.

10. The chemical imaging system of claim 5, comprising at least two said spectral filters each coupled to a respective one of at least two image collection cameras along a separate said image collection path, and further comprising at least one spectrometer coupled along one of the image collection path, for collecting a non-image spectrum of at least a selected area in an image of the sample.

11. A chemical and bio-threat imaging system, comprising:
an area provided for presentation of a sample to be imaged;
wherein the area is selectively subjected to illumination from a source comprising at least one of a laser and a wideband lamp;
image collection optics comprising at least one lens defining an optical path from the sample to at least one image collection camera;
a spectral filter at least selectively disposed along the optical path from the sample to the image collection camera, the spectral filter having a filter transmission characteristic that passes at least one wavelength passband and blocks at least one wavelength stop band;
wherein the spectral filter comprises a filter stage having a plurality of birefringent retarder elements disposed at different rotational orientations relative to an input polarization orientation, along a light propagation path leading up to at least one selection polarizer, wherein the retarder elements are arranged to impart a differential phase delay to at least one component of the wavelength passband, such that a polarization alignment of said at least one component is aligned to the selection polarizer.

12. The chemical and bio-threat imaging system of claim 11, wherein the spectral filter comprises at least one said filter stage that is a tunable stage wherein the filter transmission stage has a comb filter characteristic, and further comprising a control operable to controllably adjust the retarder elements of said tunable stage to alter the comb filter characteristic for selection of the wavelength passband that is aligned to the selection polarizer.

13. The chemical and bio-threat imaging system of claim 12, wherein the spectral filter comprises a multi-conjugate filter with at least two said filter stages, disposed serially along the light propagation path, wherein the two filter stages have different comb filter characteristics over an operational tuning range, said tunable stage being adjustable such that the comb filter characteristic of the tunable stage has at least one bandpass peak that overlaps a bandpass peak of an other of said at least two filter stages.

14. The chemical and bio-threat imaging system of claim 13, wherein the retarder elements of the tunable stage each comprises a fixed retarder and an electro-optical tunable element, a combination of the fixed retarder and the electro-optical tunable element of each of said retarder elements having a rotational orientation and a birefringence that is related to a rotational alignment and birefringence of each other of the retarder elements in the tunable stage so as to cause the bandpass peak to interfere strongly at a polarization orientation aligned to the selection polarizer, and wherein at least one of the birefringence of the retarder elements in the tunable stage and a thickness of the retarder elements in the tunable stage imparting a distinctly different phase delay from a phase delay imparted by the other of the at least two filter stages.

15. The chemical and bio-threat imaging system of claim 11, wherein the image collection camera comprises a fluorescence detection camera coupled to the image the sample through the spectral filter.

16. The chemical and bio-threat imaging system of claim 15, further comprising a broadband lamp for illuminating the specimen through at least one of an aperture control, field control and shutter.

17. The chemical and bio-threat imaging system of claim 11, wherein the source of illumination comprises a laser directed along an illumination path from the laser to the sample oriented opposite to a viewing path from the sample to a spectrometer.

18. The chemical and bio-threat imaging system of claim 17, wherein the spectrometer comprises a fiber array spectral translator with a coupling lens configured to discriminate areas of an image and to record a spectrum at a plurality of predetermined points in the image.
